(19) United States
(12) Patent Application Publication
(10) Pub. No.: US 2024/0416984 A1
(43) Pub. Date: Dec. 19, 2024

(54) HEAVY EQUIPMENT MAINTENANCE APPARATUS

(71) Applicant: Leonard Delmont Haidon, Logan Lake (CA)

(72) Inventor: Leonard Delmont Haidon, Logan Lake (CA)

(21) Appl. No.: 18/333,881

(22) Filed: Jun. 13, 2023

(51) Int. Cl. B62B 3/04; B62B 3/10

(52) U.S. Cl. CPC B62B 3/04; B62B 3/104

(57) ABSTRACT

A heavy equipment maintenance apparatus that is configured to provide a user assistance when performing maintenance on heavy equipment elements such as but not limited to wheels and tires. The present invention includes a base member wherein the base member has wheels secured the lower surface thereof. A plurality of longitudinal slots are formed in the base member and are configured to have operably coupled thereto a plurality of wheel support members. A vertical support assembly is provided and further includes an upper tray member and a lower tray member. The vertical support assembly further includes a pair of angular support members secured to opposing sides thereof. An upper support member is secured to the vertical support assembly and is configured to extend away therefrom distal to the base member. The wheel support members are further supported by the support members located adjacent the second end of the longitudinal slots.

### FIELD OF THE INVENTION

The present invention relates generally to maintenance equipment, more specifically but not by way of limitation, an apparatus configured to assist an operator in the cleaning, inspection and moving of large elements such as but not limited to wheels for mining trucks.

### BACKGROUND

Heavy equipment is employed in a variety of industries such as but not limited to construction and mining. Large equipment such as but not limited to excavators, bulldozers and dump trucks are utilized in numerous applications and can be employed to move large amounts of earth material. All equipment utilized in construction and mining is subjected to harsh conditions and as such this equipment must adhere to a rigorous maintenance protocol in order to maintain the equipment in proper working status.

In the mining industry much of the equipment is utilized twenty four hours a day seven days a week. Mines such as but not limited to coal mines operate continuously and must do so in order to maximize business objectives. The heavy equipment utilized in the mining industry requires a significant capital investment and maintenance of this equipment is critical to the operation of the mine. Dump trucks are just one of the many types of heavy equipment that run continuously during mine operations. These trucks must have maintenance performed on many elements with one element being the wheels and tires. The wheels and tires of the large dump truck can easily weigh hundreds of pounds and are difficult to maneuver. It can take two individuals to manipulate the wheels and tires which is undesirable from a time and labor cost perspective. Additionally, due to the size of the wheels and tires it can take a mechanic more time than desired to perform certain routine maintenance.

Accordingly, there is a need for a heavy equipment maintenance apparatus that is configured to assist an individual in the handling, cleaning, inspection and moving elements such as but not limited to large wheels and tires.

### SUMMARY OF THE INVENTION

It is the object of the present invention to provide a heavy equipment maintenance apparatus configured to assist a user with large wheels and tires wherein the present invention includes a base member that is generally rectangular in shape having a flat upper surface.

Another object of the present invention is to provide an apparatus configured to help a user with the maintenance process of heavy equipment wherein the base member has formed therein a plurality of longitudinal slots.

A further object of the present invention is to provide a heavy equipment maintenance apparatus configured to assist a user with large wheels and tires wherein the plurality of longitudinal slots have support members formed at one end thereof.

Yet a further object of the present invention is to provide an apparatus configured to help a user with the maintenance process of heavy equipment wherein the present invention further includes a first vertical engagement member present at a first end of the base member.

Still another object of the present invention is to provide a heavy equipment maintenance apparatus configured to assist a user with large wheels and tires wherein the present invention includes a vertical support member formed at the second end of the base member.

An additional object of the present invention is to provide an apparatus configured to help a user with the maintenance process of heavy equipment wherein the vertical support member includes a lower tray member and an upper tray member.

Yet a further object of the present invention is to provide a heavy equipment maintenance apparatus configured to assist a user with large wheels and tires wherein the present invention further includes wheel support members operably coupled to the plurality of longitudinal slots.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the present invention; and

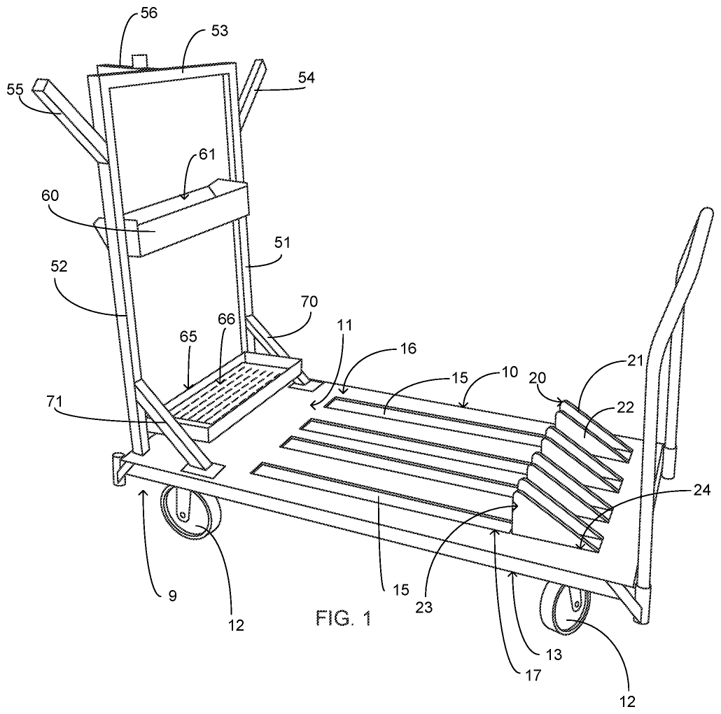

FIG. 2 is a perspective view of the present invention with the wheel support members operably coupled thereto.

### DETAILED DESCRIPTION

Referring now to the drawings submitted herewith, wherein various elements depicted therein are not necessarily drawn to scale and wherein through the views and figures like elements are referenced with identical reference numerals, there is illustrated a heavy equipment maintenance apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the heavy equipment maintenance apparatus 100 includes a base member 10 wherein the base member 10 is rectangular in shape and is manufactured from a durable rigid material such as but not limited to metal. The base member 10 includes flat upper surface 11 and further includes wheel members 12 secured to the lower surface 13 thereof. While the base member 10 is illustrated as being rectangular in shape, it is contemplated within the scope of the present invention that the base member 10 could be provided in alternate shapes and sizes. Furthermore, while the wheel members 12 are provided in order to execute movement of the heavy equipment maintenance apparatus 100, it is contemplated within the scope of the present invention that the heavy equipment maintenance apparatus 100 could employ alternate elements in place of and/or in conjunction with the wheel members 12 to facilitate movement of the heavy equipment maintenance apparatus 100.

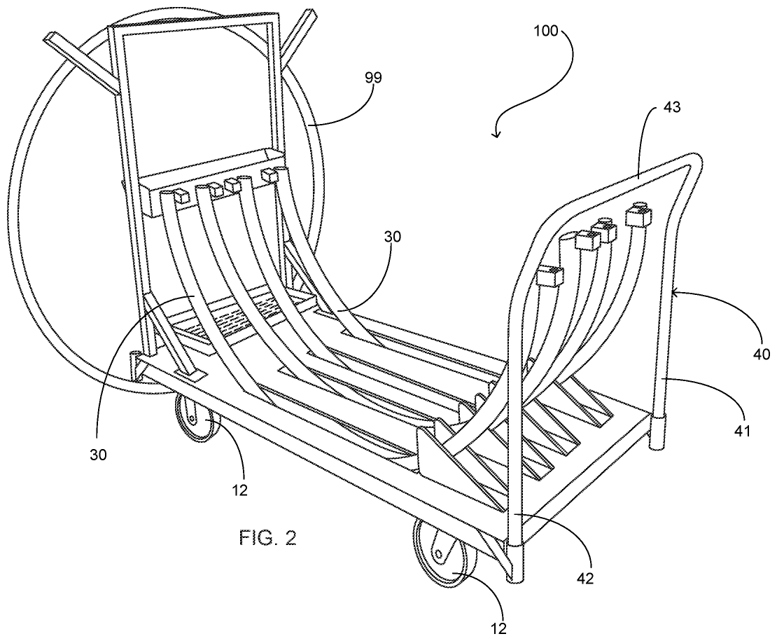

Formed in the upper surface 11 of the base member 10 are a plurality of longitudinal slots 15. The longitudinal slots 15 are rectangular in shape and have a first end 16 and second end 17. The longitudinal slots 15 are configured to receive wheel support members 30 as is further discussed herein. While four longitudinal slots 15 are illustrated in the embodiment herein, it should be understood within the scope of the present invention that the base member 10 could have more or less than four longitudinal slots 15. Secured to the upper surface 11 adjacent the second end 17 are support members 20. Support members 20 include a first plate member 21 and a second plate member 22 wherein the first plate member 21 and second plate member 22 are axially aligned with opposing edges of the longitudinal slot 15. The first plate member 21 and second plate member 22 are identically formed and parallel in orientation. The first plate member 21 and second plate member 22 are tapered in formed wherein the end 23 has a height that is greater than that of the height of end 24. This shape of the first plate member 21 and second plate member 22 provides the required engagement of the wheel support members 30 as is illustrated herein in FIG. 2. While a preferred shape of the first plate member 21 and second plate member 22 of the support members 20 has been illustrated and discussed herein, it is contemplated within the scope of the present invention that the support members 20 could be provided in alternate shapes in order to achieve the desired objective discussed herein.

Extending upward from the base member 10 is the first vertical engagement member 40. The first vertical engagement member 40 include first vertical support 41 and second vertical support 42 having a horizontal support member 43 intermediate thereto and contiguously formed therewith. The first vertical engagement member 40 provides a structure that permits a user of the heavy equipment maintenance apparatus 100 to grasp and facilitate movement of the heavy equipment maintenance apparatus 100. It is contemplated within the scope of the present invention that the first vertical engagement member 40 could be provided in alternate forms and shapes and achieve the desired objective discussed herein.

Secured to the second end 9 of the base member 10 is vertical support assembly 50. The vertical support assembly 50 includes opposing vertical support members 51,52 that are secured to the base member 10 and extend upward therefrom being perpendicular thereto. Secured to the vertical support members 51,52 is lateral support member 53 wherein the lateral support member 53 is intermediate the vertical support members 51,52 and perpendicular thereto. Secured to the lateral support member 53 extending outward therefrom opposite the base member 10 is upper support member 56. Upper support member 56 is configured to receive and retain an exemplary tire tool 99. Secured to the vertical support members 51,52 are angular support members 54,55. Angular support members 54,55 extend outward from the vertical support members 51,52 at an angle of approximately forty-five degrees. The angular support members 54,55 are provided to receive and retain maintenance elements such as but not limited to O-rings. It is contemplated within the scope of the present invention that the heavy equipment maintenance apparatus 100 could be provided with more than two or less than two angular support members 54,55. While not particularly illustrated herein, it is contemplated within the scope of the present invention that the second end 9 of the base member 10 could further be equipped with a mounting bracket to receive and retain a tire tool 99. The mounting bracket would include a horizontal support member extending the width of the base member having a slot formed therein operably to receive a portion of the tire tool 99 so as to provide holding thereof. A vertical support member would also be present along the outer edge of the horizontal support member distal to the base member 10 wherein the vertical support member extends upward and is perpendicular to the horizontal support member.

The vertical support assembly 50 further includes an upper tray member 60 and a lower tray member 65. The upper tray member 60 and lower tray member 65 are coupled intermediate the vertical support members 51,52 utilizing suitable durable techniques. The upper tray member 60 is configured with interior volume 61 that is operable to receive and retain items such as but not limited to tools and maintenance items. The lower tray member 65 is configured with grate 66 wherein grate 66 includes a plurality of apertures that facilitate an ability for fluid to flow through the grate 66. Lower tray member 65 is utilized to execute activities such as but not limited to cleaning and lubrication of parts wherein these activities may employ utilization of fluids. Angular bracket members 70,71 provide structural support for the lower tray member 65 as well as the vertical support assembly 50. While an upper tray member 60 and a lower tray member 65 are illustrated and discussed herein, it is contemplated within the scope of the present invention that the heavy equipment maintenance apparatus 100 could employ additional and/or fewer tray members.

Operably coupled to the longitudinal slots 15 are the wheel support members 30. The wheel support members 30 are manufactured from a suitable durable material such as but not limited to tubular metal. The wheel support members 30 are semi-annular in shape and subsequent coupling with the longitudinal slots 15 are spaced apart so as to assist a user of the heavy equipment maintenance apparatus 100 to receive and retain a wheel so as to perform service thereon. The support members 20 provide further lateral stability for the wheel support members 20 during use of the heavy equipment maintenance apparatus 100. The quantity of the wheel support members 30 is directly correlated to the provided quantity of longitudinal slots 15 and it should be understood within the scope of the present invention that these quantities could be different than the quantities that are illustrated in the Figures submitted herewith.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A heavy equipment maintenance apparatus configured to assist a user in performance of maintenance activities on heavy equipment wherein the heavy equipment maintenance apparatus comprises:
a base member, said base member having a first end and a second end, said base member having a flat upper surface, said base member having a lower surface, said base member being manufactured from metal;
a plurality of longitudinal slots, said plurality of longitudinal slots being formed in said base member, said plurality of longitudinal slots having a first end and a second end, said plurality of longitudinal slots being formed in said base member between said first end and said second end thereof, said plurality of longitudinal slots being parallel;
a plurality of support members, said plurality of support members being secured to said upper surface of said base member, said plurality of support members being adjacent said second end of said plurality of longitudinal slots, said plurality of support members having a first plate member and a second plate member, said first plate member being axially aligned with a first longitudinal edge of said plurality of longitudinal slots, said second plate member being axially aligned with a second longitudinal edge of said plurality of longitudinal slots, said first plate member and said second plate member having a void therebetween, said first plate member and said second plate member being parallel;
a first vertical engagement member, said first vertical engagement member being secured to said base member and extending upward therefrom, said first vertical engagement member having a first vertical support and a second vertical support, said first vertical support and said second vertical support having a horizontal support member operably coupled therebetween; and
a vertical support assembly, said vertical support assembly having a pair of vertical support members located on opposing sides of said base member, said pair of vertical support members having a lateral support member coupled therebetween proximate an upper end of the pair of vertical support members, said vertical support member further including an upper tray member, said upper tray member having an interior volume, said upper tray member being coupled between said pair of vertical support members.

2. The heavy equipment maintenance apparatus configured to assist a user in performance of maintenance activities on heavy equipment as recited in claim 1, wherein said vertical support assembly further includes an upper support member, said upper support member being secured to said lateral support member, said upper support member extending away from said base member.

3. The heavy equipment maintenance apparatus configured to assist a user in performance of maintenance activities on heavy equipment as recited in claim 2, and further including a lower tray member, said lower tray member being operably coupled intermediate said pair of vertical support members, said lower tray member being proximate a lower end of said pair of vertical support members.

4. The heavy equipment maintenance apparatus configured to assist a user in performance of maintenance activities on heavy equipment as recited in claim 3, wherein said vertical support assembly further includes at least two angular support members, said at least two angular support members being secured to said pair of vertical support members, said at least two angular support members being oriented approximately forty-five degrees to said pair of vertical support members.

5. The heavy equipment maintenance apparatus configured to assist a user in performance of maintenance activities on heavy equipment as recited in claim 4, wherein said lower tray member further includes a grate, said grate having a plurality of apertures, said grate substantially covering an opening of said lower tray member, said apertures configured to permit fluid to flow therethrough.

6. The heavy equipment maintenance apparatus configured to assist a user in performance of maintenance activities on heavy equipment as recited in claim 5, and further including a plurality of wheel support members, said wheel support members being manufactured from tubular metal, said wheel support members configured to be operably disposed in said plurality of longitudinal slots, said plurality of wheel support members being semi-annular in shape.

7. The heavy equipment maintenance apparatus configured to assist a user in performance of maintenance activities on heavy equipment as recited in claim 6, wherein said base member further includes a plurality of wheels secured to said lower surface.

8. The heavy equipment maintenance apparatus configured to assist a user in performance of maintenance activities on heavy equipment as recited in claim 7, and further including a tire inflation ring, said tire inflation ring being annular in shape, said tire inflation ring configured to be releasably secured to said upper support member.

9. The heavy equipment maintenance apparatus configured to assist a user in performance of maintenance activities on heavy equipment as recited in claim 8, wherein said first plate member includes a first end and a second end, said first plate member having a height at said first end thereof greater than a height at said second end thereof.

10. The heavy equipment maintenance apparatus configured to assist a user in performance of maintenance activities on heavy equipment as recited in claim 9, wherein said second plate member includes a first end and a second end, said second plate member having a height at said first end thereof greater than a height at said second end thereof.

11. The heavy equipment maintenance apparatus configured to assist a user in performance of maintenance activities on heavy equipment as recited in claim 10, and further including a pair of angular support members, said angular support members being coupled to said upper surface of said base member and said pair of vertical support members, wherein said lower tray member is further coupled intermediate the pair of angular support members.

12. The heavy equipment maintenance apparatus configured to assist a user in performance of maintenance activities on heavy equipment as recited in claim 11, wherein the heavy equipment maintenance apparatus is manufactured from metal.
